(19) United States
(12) Patent Application Publication
(10) Pub. No.: US 2001/0031193 A1
(43) Pub. Date: Oct. 18, 2001

(54) Truck freight rack

(75) Inventor: Claude Chevrier, Moose Jaw (CA)

Correspondence Address: FROST BROWN TODD, LLC, 2200 PNC CENTER, 201 E. FIFTH STREET, CINCINNATI, OH, 45202, US

(73) Assignee: Shur-way Mfg. Company Ltd.

(21) Appl. No.: 09/736,745

(22) Filed: Dec. 14, 2000

(30) Foreign Application Priority Data
Dec. 16, 1999 (CA) 2,292,288

(51) Int. Cl. B60P 1/00

(52) U.S. Cl. 414/522; 414/537

(57) ABSTRACT

A freight rack is disclosed for the simple loading and carriage of snowmobiles or the like in the back of a pick-up truck. The disclosed rack comprises a deck section and a retractable ramp section, which can be retracted into a storage position within the deck section. The deck section is pivotally mounted to the existing cargo bed of a pick-up truck near its rear end, such that when the ramp section is extended from the rack, the rack in total can pivot down at its rearward end defined by the extreme end of the ramp section to rest on the ground. Cargo can then be driven up the ramp section onto the deck, at which point the rack will pivot back down into the cargo bed of the truck and the ramp section can be stowed. This design has significant cost and labor efficiencies over those in the prior art.

This application is based on and claims priority of Canadian patent application Ser. No. [CA] 2,292,288 filed on Dec. 16, 1999, herein incorporated by reference in its entirety. This invention is in the field of truck loading and cargo transport apparatus, and more particularly deals with a tilting load bed for attachment in the existing cargo area of a pick-up truck.

### BACKGROUND

Pick-up trucks are common place in both urban and rural settings. Consumers find these vehicles, in various load capacities, to be quite useful for both their personal and business needs, as they can be easily used to transport various items such as freight, moving boxes, or even groceries and the like.

Trucks such as this also have the load capacity to carry larger items, such as snowmobiles and other all-terrain vehicles. Generally speaking the only problem with the carriage of such a unit on a pick-up truck is getting the unit loaded onto the truck. For example, with snowmobiles the methods of loading might include three or four people physically lifting the unit into the back of the truck, backing the truck into the side of a hill where the unit can be driven on or off of the tailgate of the truck, or various other elaborate ramp, loading or carriage mechanisms which have also been conceived. Many of these units, however, are very complex and defeat the purpose of quick and easy loading and unloading of such equipment from the back of a pick-up truck.

In addition, varying truck sizes cause the manufacturers of current items to manufacture in many different sizes, or provide a product which is not particularly tailored to the size of the truck freight area or box. It would be preferable to have a freight rack which could be adjusted for variations in size or length of trucks, as well as to accommodate surface deviations in the base of the freight area such as wheel wells, or the necessity to carry some limited cargo on the truck deck below the rack.

### SUMMARY OF THE INVENTION

It is the object of the present invention to provide a truck freight rack for the carriage of snowmobiles and other various cargo, which freight rack is pivotally mounted in the freight area of a truck and onto which cargo can be driven or placed.

It is the further object of the present invention to provide such a tilting truck freight rack which does not require any motor or other equipment to tilt it back up into its transport position once loaded—the positioning of the load will accomplish this.

It is the further object of the present invention to provide a tilting truck freight rack which is adjustable in many of its dimensions and mounting configurations, to better fit a larger variety of vehicles than any freight rack currently on the market.

The present invention, a freight rack for use on a truck having a freight area with a front end and a rear end and side edges extending therebetween, along with truck pivot hardware at reflective points at or near each side edge of the freight area, accomplishes these goals comprising a deck section having a forward end and rearward end and two deck side members therebetween defining two side edges of the deck section, the top of the deck section defining a load carrying plane; a ramp section having a forward end and a rearward end and two ramp side members extending therebetween defining two side edges of the ramp section, the top of the ramp section defining a loading ramp, and wherein said ramp section is slidably attached to the deck section such that it can be retracted below the load carrying plane; and pivot engaging hardware at corresponding points on either side edge of the deck section, said pivot engaging hardware to rotatably engage the truck pivot hardware; wherein the freight rack can be placed in a loading position by extending the ramp section from the rearward end of the deck section and pivoting the rearward end of the ramp section down to the ground; and wherein the freight rack can be placed in a transport position by pivoting the freight rack into approximate planar alignment with the freight area of the truck and retracting the ramp section beneath the deck section.

The freight area of the truck might be a box, in the case of a conventional pick-up truck. In the case where the truck is a pick-up truck with a box with a removable end gate, upon removal of the end gate, the truck pivot hardware for attachment to the freight rack might be the pivot posts for the end gate.

It is also possible that the freight rack of the present invention could be mounted on a truck with a flat deck, frame only or in another situation, and all such variations shall be contemplated within the scope of the present invention.

The length of the deck section behind the pivot engaging hardware towards the rearward end of the deck section could extend to or past the extreme rearward end of the truck.

Various load or freight configurations and attachments could be used with this basic freight rack of the present invention. For example, ski runners and a central load plate might be mounted and sized in order to engage the skis and driving track of a snowmobile. The position of the ski runners in relation to the central load plate might be made adjustable, in order to accommodate snowmobiles of various ski widths. In one such embodiment, the deck side members might comprise the ski runners.

In another situation, a flat plate might be placed overtop of the deck section between the deck side members to provide for a simple planar loading surface. Another alternative would be the use of wheel runners mounted on the ramp and deck sections and mounted and sized such as to engage the wheels of one or more wheeled vehicles.

Similar to the deck section, the ramp section might also have a surface attached thereto for load bearing purposes. Again, the ramp surface might comprise ski runners and a central ramp plate mounted and sized to engage the skis and track of a snowmobile, a load plate or wheel runners.

A raising structure might be added to lift the freight rack above the surface of the freight area of the truck, wherein the raising structure would extend downwards from the lower edge of the deck section and have the pivot engaging hardware displaced at the extreme end thereof. As such, the pivot engagement and actual pivoting action of the freight rack would still take place at or near the surface of the freight area of the truck while the freight rack itself was mounted some distance above the surface of the freight area of the truck.

More than one deck section could be used such that each deck section, each with its own corresponding ramp section, could be operated independently of the others. This would allow for the loading or handling or more than one cargo load or vehicle on the freight rack at the same time.

The pivot engaging hardware could be made adjustable in width to be easily adaptable to fit into various trucks. In one such embodiment, the pivot engaging hardware on each side of the freight rack might comprise a circular pipe within a collar which pipe could be selectively extended outwards through the collar to engage its respective truck pivot hardware, and locked.

The position of the pivot engaging hardware in relation to the rearward end of the deck section could also be rendered adjustable.

The width of the deck section might be made adjustable in certain circumstances by shifting the position of the deck side members. Similarly, the width of the ramp section could also be rendered adjustable by making the ramp side members adjustable inwards and outwards, within the confines of the spacing of the deck side members.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a basic side view of a pickup truck with an embodiment of the present invention in its transport position;

FIG. 2 shows the embodiment of FIG. 1 in its loading position;

FIG. 3 shows one basic embodiment of the freight rack of the present invention in a partially extended position, with a load-bearing plate on the ramp and deck sections;

FIG. 4 is a top view of another embodiment of the freight rack of the present invention showing ski runners and a central load plate;

FIG. 5 shows a variation on the embodiment of FIG. 4 wherein the width of the deck and ramp sections are adjustable;

FIG. 6 is an end view of a raising frame with a freight rack of one embodiment of the present invention attached thereto;

FIG. 7 is a side view of the embodiment FIG. 7;

FIG. 8 is an end view of one embodiment of the present invention showing a raising frame with two independent deck sections attached thereto.

### DETAILED DESCRIPTION OF THE ILLUSTRATED EMBODIMENTS:

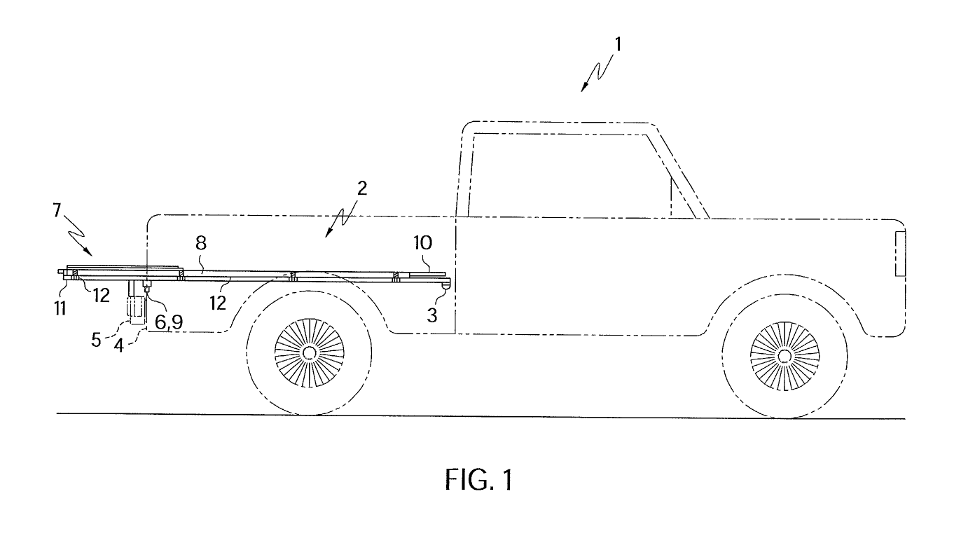

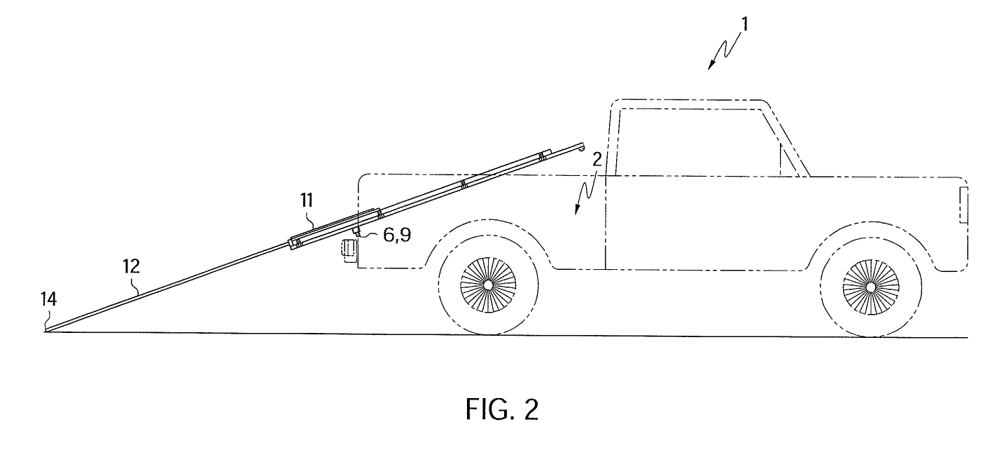

As outlined above, the present invention is a truck rack for use in the freight area of a truck. FIGS. 1 and 2 demonstrate the basic concept of the freight rack of the basic invention.

FIG. 1 demonstrates a side view of a pick-up truck with an embodiment of the present invention in its transport position. The truck (1) is shown, the truck freight area (2) in this case being the freight area defined by the box of the pick-up truck. The front and rear ends (3) and (4) of the truck freight area are the front and rear ends of the truck box. The extreme rearward end (5) of the truck (1) is also shown.

On each side of the truck box is a truck pivot hardware (6). The two truck pivot hardwares (6) are at reflective points at or near each side edge of the freight area (2) insofar as they are at equivalent points on either side of the truck freight area (2) and are equal distances from the extreme rearward end of the truck (5).

The freight rack of the present invention is shown at (7). It is attached to the truck pivot hardware (6) within the truck freight area (2). It can also be seen in these diagrams that in this particular embodiment the deck section (8) is longer than the length of the freight area (2) of the truck (1) and the pivot engaging hardware (9) which engages the truck pivot hardware (6), on each side of the freight area (2) has been placed some distance ahead of the rearward end (11) of the deck section (8). The front end of the deck section is shown at (10). It will be understood that the pivot engaging hardware (9) and the truck pivot hardware (6) could be placed in a different position in relation to the deck section (9) or the truck freight area (2), so long as the tilting motion of the freight rack (7) into the loading position is not impeded. The placement of such hardware in such position or rendering the pivot engaging hardware adjustable, as discussed otherwise herein, are contemplated within the scope of the present invention. In FIG. 1, the ramp section (12) is shown in its collapsed position within the deck section (8), and the freight rack (7) is in its raised transport position wherein it is roughly in alignment with the remainder of the truck freight area (2).

In FIG. 2, the loading position of the apparatus is demonstrated wherein the ramp section (12) is extended from the rearward end (11) of the deck section and the extended ramp and deck sections then pivot down about the point of attachment of the pivot engaging hardware (9) and truck pivot hardware (6) to rest the rearward end of the ramp section (14) on the ground.

Also shown in FIGS. 1 and 2 is a lock attached to the rear bumper of the truck, which can be used to lock the freight rack of the present invention in its raised position.

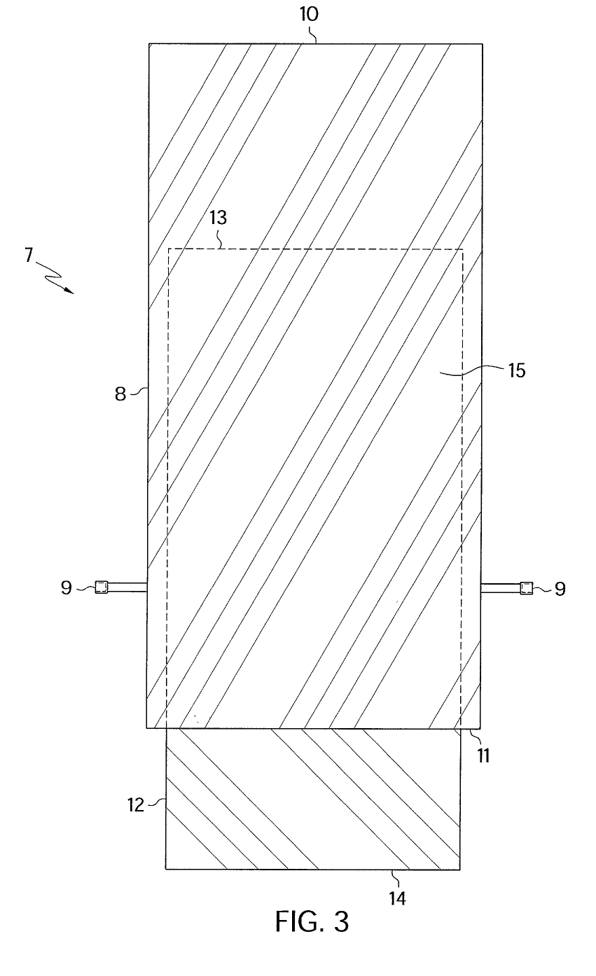

FIG. 3 demonstrates one embodiment of the freight rack of the present invention, not attached in a truck at the time, in a partially extended position. The load bearing plane (15) of that embodiment consists of a full load plate attached to the top of both the deck section (8) and the ramp section (12). The freight rack (7) consists of a deck section (8) and a ramp section (12), and would rest between the edges of a truck freight area. The top of the deck section (8) defines a load bearing plane on which a load can be placed, or other load carrying hardware or surfaces, such as the full load plate demonstrated herein, can be mounted. Further embodiments of these types of load accommodating attachments will be discussed further subsequently. The ramp section (12) is slidably attached to the deck section (8) so that it can be extended out from the back of the deck section (8) by pulling the rearward end (14) thereof (the forward end being numbered (13)) out from the rearward end (11) of the deck section (the forward end of the deck section being numbered (10)) into an extended loading position, or alternatively can be stored in the stowed position beneath the load bearing plane (15) of the deck section (8) by sliding it back into its well within the deck section (8).

Also shown in FIG. 3 are the pivot engaging hardware (9), disposed at corresponding points on either side of the deck section (8). The pivot engaging hardware (9) defining the center pivot point of the freight rack (7) around which the rack (7) will pivot and tilt when attached to the truck. It will be understood that various pivot engaging hardware might be used, depending on the manner of attachment to the truck or the hardware available on the truck, and that such modifications to the pivot engaging hardware that achieve the same result of pivotally engaging the freight rack (7) to the truck are all contemplated within the scope of the present invention.

There are many methods of slidably attaching the deck section (8) and the ramp section (12). One of the easiest ways of doing this would be to have an inward facing channel on each of the deck side members, within which the ramp side edges or side members could slide, making the ramp section retractable within the deck section. It will be understood, however, that there are other methods of adapting engaging the ramp section and the deck section with the same result of their slidable retraction will be achieved and that such modifications or adaptations are contemplated within the scope of the present invention and the claims thereto. As will be demonstrated in subsequent figures, it is also possible to attach the two sections of the freight rack (7) together using bushings. These bushings can act as guides for the sliding action of the ramp section.

Further additions could be made to the load bearing plane (15) of the freight rack (7) to accommodate the carriage of various cargos. This might include the addition of wheel runners on the load bearing plane, or other load carrying hardware.

Load plates and decking used on the invention, it will be understood, could be made of solid sheet metal or other material, or could also be made of something like expanded metal or the like for strength with light weight. It will be understood that, insofar as the precise material of manufacture is not determinative of the effectiveness of the invention as a whole, any type of manufacturing material is contemplated within the scope of the present invention. It will also be understood that other optional attachments could be added to the freight rack (7) of the present invention to accommodate different cargos and insofar as those attachments do not depart from the intention of the present invention, namely the ability to provide an extensible freight rack (7) which will automatically pivot itself into a raised transport position upon movement of the load beyond the center pivot point of the freight rack (7) in attachment to the truck, those will also be contemplated within the scope of the present invention.

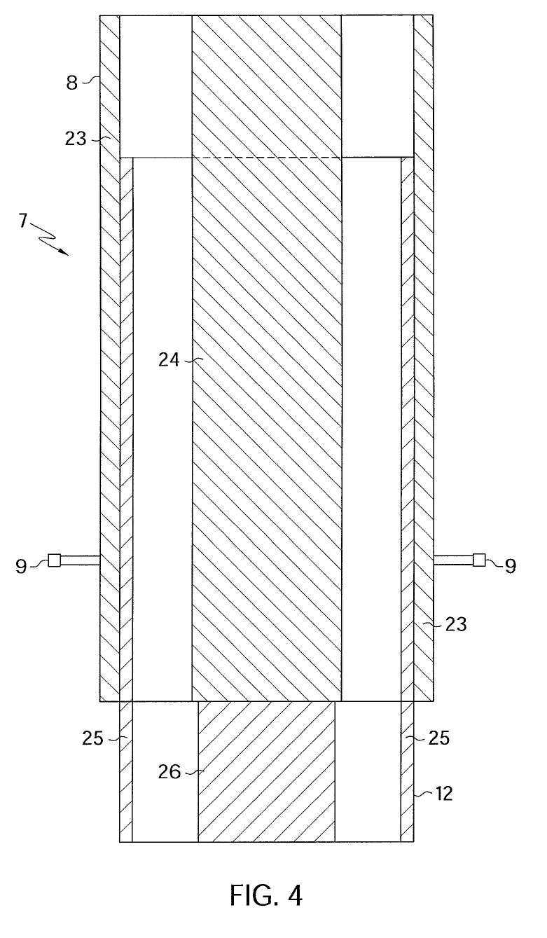

FIG. 4 shows a top view of another embodiment of the present invention which has been specifically modified for the carriage of snowmobiles. There is shown a deck central load plate (24) and a central ramp plate (26) attached along the center line of the deck section (8) and the ramp section (12) respectively. Also attached to the deck and the ramp sections (8) and (12) are ski runners (23) and (25) which would accommodate the skis of the snowmobile. The central load plates (24) and (26) would mate with and support the central drive track of a snowmobile. In the case of a snowmobile being carried, a gripping material such as expanded metal would have particular use as the material of manufacture of the central load plates (24) and (26), since it would provide for maximum grip between the track of a snowmobile and the freight rack (7) while the snowmobile was being driven into position.

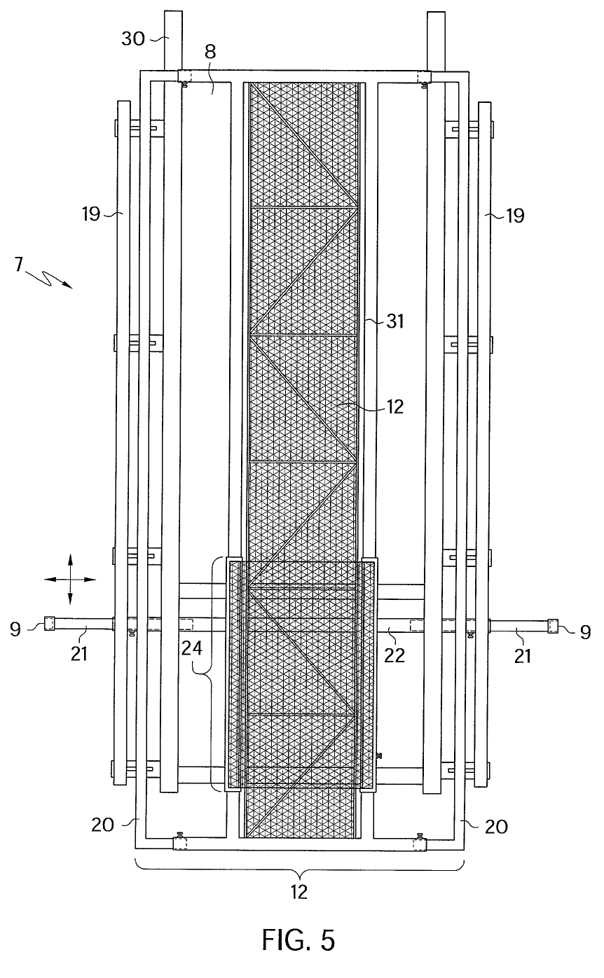

FIG. 5 shows another embodiment of the present invention, wherein the widths of the deck and ramp sections (8) and (12) are adjustable to some extent. This particular embodiment is specifically designed again for the carriage of snowmobiles. The deck section (8) of this embodiment includes a central frame (30) to which the ramp section (12) will be engaged. This is because the outer edges of both the ramp section (12) and the deck section (8) can be adjusted to vary the width of the freight rack (7). This will be important in allowing the freight rack (7) to accommodate snowmobiles of various ski stances.

In this case, the deck side members (19) are shown attached to the deck central frame (30) in such a manner that they can be anchored in position once slid to the lateral position desired.

The ramp section (12) of this embodiment also has a central frame (31), which frame (31) engages the central frame (30) of the deck section (8) to provide for the retractable movement of the ramp section (12) below the load bearing plane. Similar to the deck section (8), the ramp section (12) is also rendered adjustable in width by attaching the ramp side members (20) to the central frame (31) of the ramp section (12) such that they can be slid into the desired lateral position and then anchored. Set screws or the like might be used to lock both the adjustable ramp side members (20) and the adjustable deck side members (19) in their positions. In this embodiment, the combination of the deck side members and the ramp side members act as the ski runners.

In this particular case, the load bearing plane is defined along its outer edges solely by the tops of the deck side members (19). Also shown in this embodiment is a central load plate (24), in this case of expanded metal, upon which the drive track of a snowmobile could be driven and could rest. The deck side members (19) could engage the skis of the snowmobile over only a portion of the width of those skis, allowing for less friction of the unit when it is loaded, as well as lightening the overall freight rack (7) by not requiring a full width deck plate. Another method of lightening the overall freight rack (7) is shown in this embodiment as well, insofar as the central load plate (24) is not of the full length of the deck section (8). It is only long enough to accommodate the track at the rear of a snowmobile.

When the freight rack (7) of this embodiment is in its extended loading position, with a ramp section (12) slid out from the back of the deck section (8), it can be seen that the ramp side members (20) can be adjusted to occupy such a position in close proximity to, but inside of, the deck side members (19) that the ramp side members (20) would similarly act as the ski runners, as do the deck side members (19), discussed above. The ski of the snowmobile would be engaged along its inner edge or inner portion thereof by the ramp side member/ski runner (20) until the snowmobile reached the deck section (8) of the freight rack (7), at which point the ski would engage the deck side member (19), which would become primarily responsible for the carriage of the snowmobile ski and supporting the snowmobile load on the freight rack (7).

The deck side member and ramp side member, (19) and (20) respectively, could also be spaced apart to engage a protuberance from, for example, a snowmobile ski, to provide yet another guidance method for loading the snowmobile properly onto the unit (7).

Also demonstrated in the embodiment of this figure is a dually adjustable pivot engaging hardware (9). The position of the pivot engaging hardware (9) with respect to the remainder of the deck section (8) can be adjusted, as well as the length of the pivot engaging members which extend outwards from the side of the deck section (8) are also adjustable.

The pivot engaging hardware (9) is made moveable along the length of the deck section (8) by clamping it in position to the deck section (8) or, in this particular embodiment, by clamping it in position to the central frame (30) of the deck section (8). The clamps can be loosened and the pivot engaging hardware (9) moved depending on the size of the truck on which the freight rack (7) is to be positioned.

The pivot engaging hardware (9) can also be extended laterally within the box or freight area of the truck to engage whatever freight rack attachment points or truck pivot hardware (6) are desired to be used. In this particular case, both of these adjustments are accomplished by using first of all a collar (22) on each side of the deck section (8). In this particular case, the collar (22) is one continuous length of cylindrical tubing extending across beneath the central frame (30) and clamped in position to the central frame (30). Thus, the first adjustment is accomplished and allowed. Secondly, to allow for the extensible adjustment of the pivot engaging hardware (9), individual lengths of pipe (21) are used within the collar (22) to extend outwards to the truck pivot hardware. The pivot engaging end of the pipe (21) can be adapted to engage various types of truck pivot hardware, whether those be pre-existing hardware on the truck itself or some portion of a raising frame or the like, discussed in further detail below. Once these pipes (21) are adjusted to the proper position they can be locked in place by the use of a set screw or other conventional means.

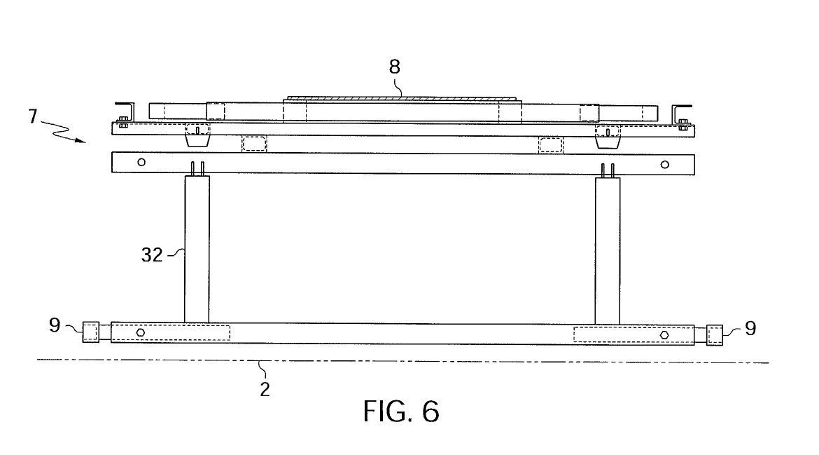

In certain cases, such as those of using the freight rack of the present invention within a truck box where there are wheel wells over which the freight rack need to be positioned, or where there is some other deviation in the surface of the freight area of the truck, or where it is simply desired to retain some amount of cargo space below the freight rack in its raised transport position, a raising structure can be used. This is demonstrated in FIG. 6. The raising frame (32) is essentially a frame which can be mounted to the bottom of the freight rack (7) and extends downwards from the freight rack (7) having the pivot engaging hardware (9) displaced at the extreme end thereof, which can then in turn engage the truck pivot hardware. This would allow for the placement of the freight rack (7)/deck section (8) in relative plane or alignment with the floor of the truck freight area (2), but at some distance above the floor of the truck freight area.

Where a raising frame (32) is used, the same adjustable type of pivot engaging hardware (9) could be used to attach the freight rack (7) to the truck pivot hardware. The pipe and collar setup shown in FIG. 5 in detail could be used again to mount the raising frame (32) to the truck pivot hardware/end gate posts.

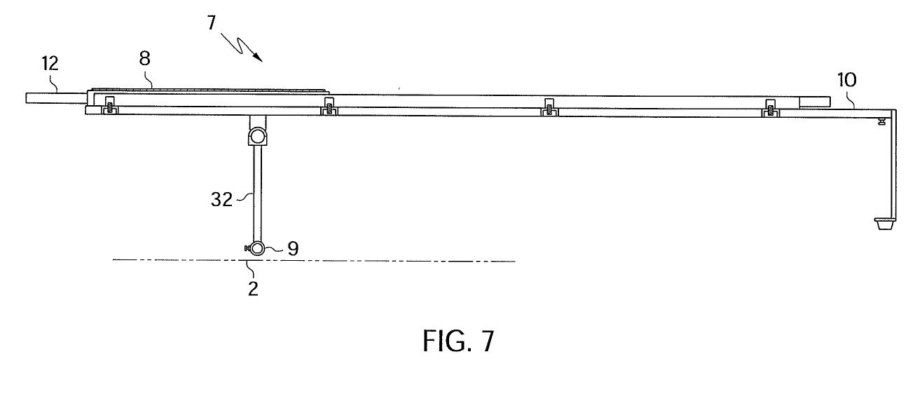

FIG. 7 is a side view of the raising frame (32) of FIG. 6 attached to a freight rack (7), said freight rack (7) being displayed in its partially retracted transport position. Also shown towards the forward end (10) of the deck section is a rest extending downwards to the floor of the truck freight area to rest thereon and support the front end (10) of the deck section. Alternatively, a rest could also be provided extending upwards from the floor of the truck freight area and upon which the deck section (8) would rest when in its lowered transport position.

It will be understood that various other forms of raising frames, rest frames or methods of raising the pivot point and attachment of the freight rack above the wheel wells or other impediments on the floor of the freight area of the truck are conceivable and all are contemplated within the scope of the present invention to the extent that they accomplish the same objective.

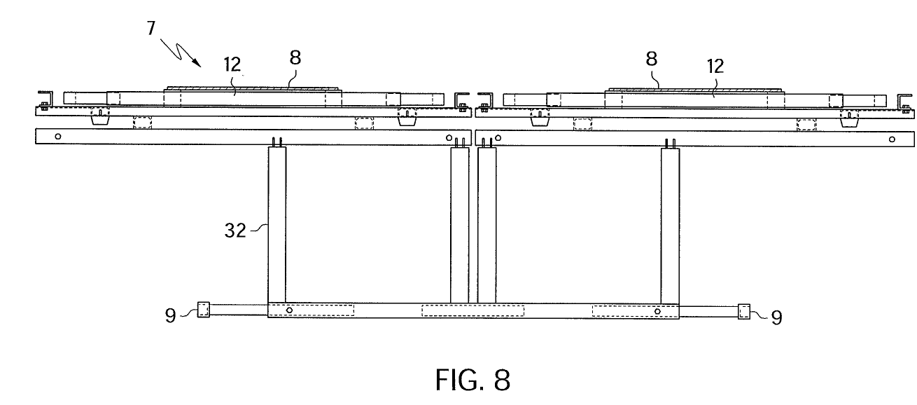

FIG. 8 shows another embodiment of a freight rack (7) for use in a truck wherein more than one deck section (8), each with its own corresponding ramp section (12) is used. Particularly, in this particular embodiment, two independent deck sections (8) are shown attached to a single raising structure (32). These deck sections (8) could operate independently of each other and would allow, for example, for the carriage of two snowmobiles in the back of one truck.

Thus it can be seen that the invention accomplishes all of its stated objectives. The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. A freight rack for use on a truck, said truck having a freight area with a front end and a rear end and two side edges extending therebetween, and having truck pivot hardware at reflective points at or near each side edge of said freight area, said freight rack itself comprising:
a) a deck section having a forward end and rearward end and two deck side members therebetween defining two side edges of the deck section, the top of said deck section defining a load carrying plane;
b) a ramp section having a forward end and a rearward end and two ramp side members extending therebetween defining two side edges of the ramp section, the top of the ramp section defining a loading ramp, wherein said ramp section is slidably attached to said deck section such that it can be retracted below the load bearing plane; and
c) pivot engaging hardware at corresponding center pivot points on either side edge of said deck section, said pivot engaging hardware to rotatably engage said truck pivot hardware;
wherein said freight rack can be placed in a loading position by extending the ramp section from the rearward end of the deck section and pivoting the rearward end of the ramp section down to the ground;
and wherein said freight rack can be placed in a transport position by pivoting said freight rack into approximate planar alignment with the freight area of the truck and retracting said ramp section beneath said deck section.

2. The freight rack of claim 1 wherein the freight area of the truck is a box.

3. The freight rack of claim 3 wherein the truck pivot hardware are the pivot posts used to attach an end gate to the truck box.

5. The freight rack of claim 3 wherein the length of the deck section beyond the pivot-engaging hardware towards the rearward end of said deck section is such that the rearward end of said deck section is at or past the extreme rearward end of the truck.

6. The freight rack of claim 1 wherein the deck side members have an inwardly facing channel, and the ramp side members are engaged by and slide within the channels defined by the deck side members.

7. The freight rack of claim 1 further comprising ski runners and a central load plate mounted and sized to engage the skis and driving track of a snowmobile.

8. The freight rack of claim 7 wherein the position of the ski runners in relation to the central load plate is adjustable, in order to accommodate snowmobiles of different ski widths.

9. The freight rack of claim 7 wherein the deck side members are the ski runners.

10. The freight rack of claim 1 further comprising a flat plate covering the top of the deck section between the deck side members.

11. The freight deck of claim 1 further comprising wheel runners mounted and sized to engage the wheels of a wheeled vehicle.

12. The freight rack of claim 1 further comprising a ramp surface attached to the top of the ramp section.

13. The freight rack of claim 12 wherein said ramp surface comprises ski runners and a central ramp plate mounted and sized to engage the skis and driving track of a snowmobile.

14. The freight rack of claim 13 wherein the position of the ski runners in relation to the central ramp plate is adjustable, in order to accommodate snowmobiles of different ski widths.

15. The freight rack of claim 14 wherein the ramp side members are the ski runners.

16. The freight rack of claim 12 wherein the ramp surface comprises a plate covering the top of the ramp section between the ramp side members.

17. The freight deck of claim 12 wherein the ramp surface comprises wheel runners mounted and sized to engage the wheels of a wheeled vehicle.

18. The freight rack of claim 1 further comprising a raising structure for mounting the freight rack above the surface of the freight area of the truck, said raising structure extending downwards from the lower edge of the deck section and having the pivot engaging hardware displaced at the extreme end thereof.

19. The freight rack of claim 1 wherein the deck section comprises more than one deck section, each with its own corresponding ramp section, each of which deck sections can be operated independently of the others.

20. The freight rack of claim 1 wherein the pivot engaging hardware is adjustable in width.

21. The freight rack of claim 20 wherein the pivot engaging hardware on each side of the freight rack comprises a circular pipe within a collar which pipe can be selectively and lockably extended outwards through said collar to engage its respective truck pivot hardware.

22. The freight rack of claim 1 wherein the position of the pivot engaging hardware in relation to the rearward end of the deck section is adjustable.

23. The freight rack of claim 1 wherein the width of the deck section is adjustable by shifting the position of the deck side members.

24. The freight rack of claim 1 wherein the width of the ramp section is adjustable by shifting the position of the ramp side members.
